(19) United States
(12) Patent Application Publication
(10) Pub. No.: US 2007/0206739 A1
(43) Pub. Date: Sep. 6, 2007

(54) Integrated fax and voice messaging

(76) Inventors: Steven Livengood, Laguna Niguel, CA (US); Brent Richtsmeier, Laguna Niguel, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/361,864

(22) Filed: Feb. 23, 2006

(51) Int. Cl. H04M 11/00

(52) U.S. Cl. 379/100.01

(57) ABSTRACT

Systems and method for providing integrated fax and voice messaging are provided. At the time a fax request is created, a user can enter one or more voice messages to accompany the fax message to be played upon delivery. The audio message is integrated into the fax message as digital sound data. Upon receiving an integrated fax message, a receiving fax device separates the audio data from the fax data. The fax data is printed, and the recipient may listen to the audio message.

### BACKGROUND OF THE INVENTION

1. Field of the Invention

This application is related to the field of facsimile communications. In particular, this application relates to systems and methods for providing facsimile communications by integrating voice and audio data with fax data.

2. Description of the Related Art

Currently, fax-capable devices are configured to communicate via telephone or networking connections such as fax over IP, to send and receive fax messages. In a typical faxing situation, the sender will often include a cover sheet with the information to be faxed in order to provide information about the contents of the fax to the recipient. For example, a cover sheet may include the sender's identity, the sender's telephone number and/or facsimile number, the number of sheets included in the fax, or some other information. Additionally, fax cover sheets may also include a short summary of the contents of the fax so that the recipient is able to determine the contents of the fax message with a brief glance at the cover sheet. The cover sheet may also include the recipient's specific identity, in cases where the recipient's fax machine is used by several people.

Often times, the creation of the fax cover page may take several minutes because the sender must first type the relevant information and then must print that information on a printer. Thus, even in cases where the information on the cover sheet is relatively brief, the sender must still create the cover page. It would therefore be an improvement to provide a way for the sender to include fax cover sheet information in a fax without having to take the time to create a separate cover page.

Current fax machines also may include the ability to notify a user of the receipt of an incoming fax. Typically, this notification is in the form of a text message sent to the recipient electronically. The fax machine holds the message while the recipient is notfied that the message is present and received. Upon receiving the notification, the user then may instruct the receiving fax machine to print the fax. Current implementations of fax notifications do not allow for the specification of the identity of the sending user. For example, a typical notification message may include the sending fax number, but it will not include the identity of the sending party. It would therefore be useful to provide a mechanism by which a notification could include more detailed information to provide to the fax recipient.

### SUMMARY OF THE INVENTION

The system, method, and devices of the present invention each have several aspects, no single one of which is solely responsible for its desirable attributes. Without limiting the scope of this invention, several of its features will now be discussed briefly.

In accordance with one more aspects of the invention, a fax device is provided. The fax device includes a transceiver configured to receive a fax message that is intended for recipient, the fax message comprising voice data and fax data. The fax device also may include a memory or data storage device configured to store the received message. The fax device also includes a processor configured to separate the voice data from the fax data, and further configured to convert the voice data into audible sound waves in response to a command to play the voice data. The fax device also includes a sound interface configured to receive the converted voice data from the processor and to play the voice data.

In another embodiment, a fax device comprising a fax data input interface is configured to receive fax data. The fax device also includes a voice data input interface configured to receive voice data, the voice data being related to the fax data. The fax device also includes a memory configured to store the received fax data and the received voice data and a processor configured to associate the stored fax data with the stored voice data. The fax device additionally includes a network interface configured to send the associated fax data and voice data as a fax message to a communications network.

In another embodiment, a method of managing an integrated fax and audio message is provided. The method includes receiving an integrated fax and audio message. The integrated fax and audio message has an intended recipient. The message also includes fax data and audio data.

In yet another embodiment a method of sending a fax message from a fax device to and intended recipient is provided. The method includes receiving fax data into the fax device and receiving audio data into the fax device. The audio data is associated with the fax data to create a fax message. The fax message is sent to the recipient over a communications network.

### BRIEF DESCRIPTION OF THE DRAWINGS

FIG. 1 provides a perspective view of an illustrative fax device according to one or more aspects of the invention.

FIG. 2 is a block diagram that illustrates various internal components that may be included in the fax device of FIG. 1.

FIG. 3A provides an example of two fax machines in communication via a communications network in accordance with aspects of the invention.

FIG. 3B illustrates a multi-component/multi-network system according to an aspect of the invention.

FIG. 4 illustrates the conceptual high-level data structure of a coventional fax message.

FIGS. 5A-5D provide conceptual high-level data structures of fax messages according to one or more aspects of the invention.

FIG. 6 is a flow chart illustrating a method of managing in integrated fax an audio message in a fax machine according to one more aspect of the invention.

FIG. 7 provides an alternative embodiment for a method of managing an integrated fax and audio message in accordance with one or more aspects of the invention.

FIG. 8 is a flow chart that illustrates a method of sending a fax message from a fax device to an intended recipient according to or one more aspects of the invention.

In this description, reference is made to the drawings wherein like parts are designated with like numerals throughout.

### DETAILED DESCRIPTION OF EMBODIMENTS

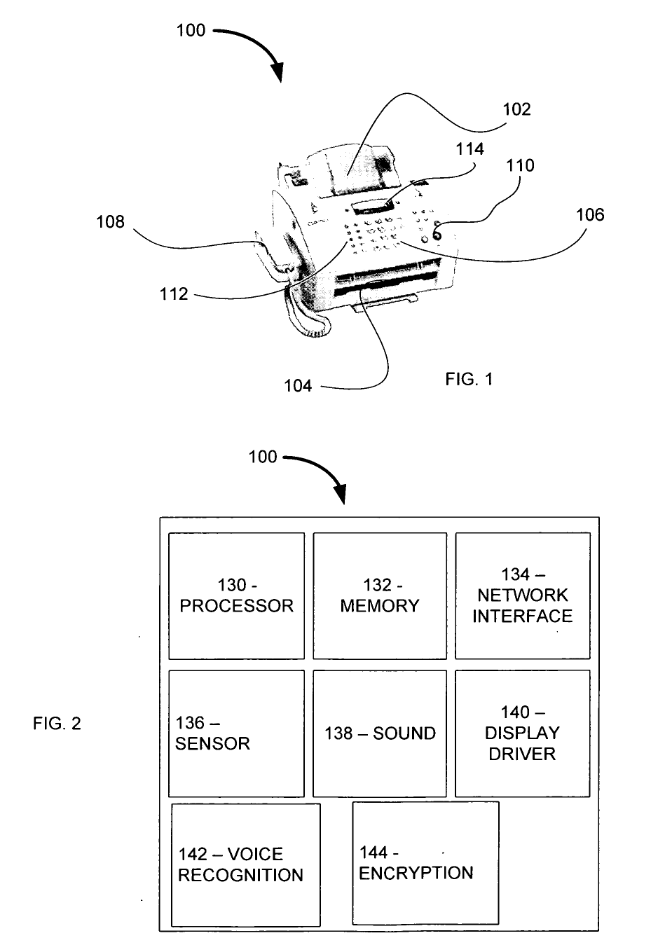

One or more aspects of the invention involve allowing a user of a fax device to include one or more voice messages that are associated with and accompany a faxed document as it is transmitting across a communications network. The voice message is integrated into the fax data and transmitted via the same channel to a receiving fax device. The receiving fax device recognizes the message as including the voice data, and is configured to separate the document data from the voice data, and print the document and play the voice message for the intended recipient. Various embodiments may be implemented utilizing a fax device adapted to integrate audio data with sound data as provided in FIGS. 1 and 2.

Referring to FIG. 1, an illustrative fax device 100 is provided. Fax device 100 includes a paper feeder/tray 102 which may serve two purposes. First, it may be used to hold paper to feed into the fax device 100 for printing received fax messages and confirmation pages. Upon receiving a command to print a fax, paper feeder 102 will send one or more sheets into the printing area of the fax device 100 so that the received fax image can be printed onto the paper. Second, paper feeder 102 may include a mechanism that allows a user to easily send multi-page faxes by drawing pages seriatim into the machine for scanning and sending. Fax device 100 also includes an output tray 104 which receives printed and scanned/sent pages from the printing/scanning area of fax device 100.

Fax device 100 also may include a keypad 106 which can be used by a user to input a telephone or fax number to which a fax message or telephone call might be sent. If the user is placing a telephone call, he may utilize handset 108. Handset 108 may also provide an interface for the input of voice or audio data into the fax device 100. Although handset 108 is shown as a telephone like device in figure one, one of skill in the art will readily appreciate that voice or audio data input may be provided by some other input device such as a microphone connected to fax device 100, or a data interface that may receive digital sound via a separate device such as a Bluetooth-capable handheld computer.

Typically, a user picks up the handset 108 and presses a series of digits on the keypad 106 in order to place a call or produce a fax connection. If the user chooses to send a fax, then the user may place the document to be faxed on the paper feeder 102, and then enter the fax number for the recipient and press the send button 110. Alternatively, the fax device 100 may include speed dial buttons 112, which may be configured for one-touch access to particular phone numbers. Thus, a user may program the speed dial buttons 112 with fax numbers that are regularly used. The fax device 100 may also include a display 114. Display 114 may be an LCD display or some other type of display. Typically, display 114 will provide information such as the status of the fax device 100, or some other notification intended for the user.

In one embodiment, fax device 100 may be a CCITT (ITU-T) Group 3 Facsimile machine that can communicate with other Group 3 fax devices. Alternatively, fax device 100 may be a multi-purpose device which, in addition to providing fax service, may also provide scanning and/or printing. In addition, fax device 100 may support various Internet functions and services such as scan-to-email, or fax-to-email when connected to a network.

FIG. 2 provides a block diagram illustrating components of fax device 100. Although the block diagram in FIG. 2 illustrates various components that may be part of the fax device 100, a fax device 100 according to one or more embodiments may be missing some of the components shown in the Figure, and may be comprised of other additional components without departing from the scope of the invention. The fax device 100 includes a processor 130, which receives data from various other system components and processes the data according to programming and instructions stored in fax device 100. Fax device 100 also includes a memory or data storage device 132, which may be used to store received fax images, or fax messages being sent by the machine. Memory 132 may also be configured to store data such as speed dial numbers, sending and receiving history, or other additional data.

Fax device 100 may also include a network interface 134. The network interface 134 may be a modem, a network card, or some other apparatus that allows the fax device 100 to communicate with a network in order to send and receive data. Fax device 100 also may include a sensor 136 which is used to scan documents to provide an image that will be sent to a recipient. The sensor 136 may be a photo diode sensing array, a CCD (charge-coupled device), a CMOS (complimentary metal-oxide semiconductor), or some other photo sensing device.

The fax device 100 also may include a sound interface 138, which is configured to process sound and convert it to and from digital data. Sound interface 138 may be a sound card such as a Sound Blaster-compatible card or some other sound card as is known in the art. Sound interface 138 may be configured to receive sound via a handset 108 or some other audio input device, and convert it to an audio format such as .wav, .MP3, .WMA, or some other digital audio format. Fax device 100 may also include a display driver 140, which converts data into an image to be displayed on the display 114. Display driver 140 may be a video card, or it may be software stored in the memory 132, which is processed by processor 130. Fax device 100 also may include voice recognition software 142 which can receive voice data from the handset 108 or some other audio or voice input device, and convert it into a text message which can be sent via SMS or some other text based messaging format.

Although the various components in the fax device 100 have been described separately, one of skill in the art will appreciate that the components need not be physically separate devices, and the functions performed by these components may generally be integrated into multi-purpose components. By way of example and not of limitation, processor 130 may be an integrated processor which includes the sound interface 138 and the video display driver 140. In addition, the memory/storage area 132 may be included in the processor 130. Fax device 100 may also include voice recognition software 142 stored in the memory 132. Voice recognition software 142 receives voice data from the sound interface 138, and converts it into text. Fax device 100 also includes an encryption module 144, which may be used to encrypt data using encryption techniques such as PKI, PGP, SSL or other encryption schemes.

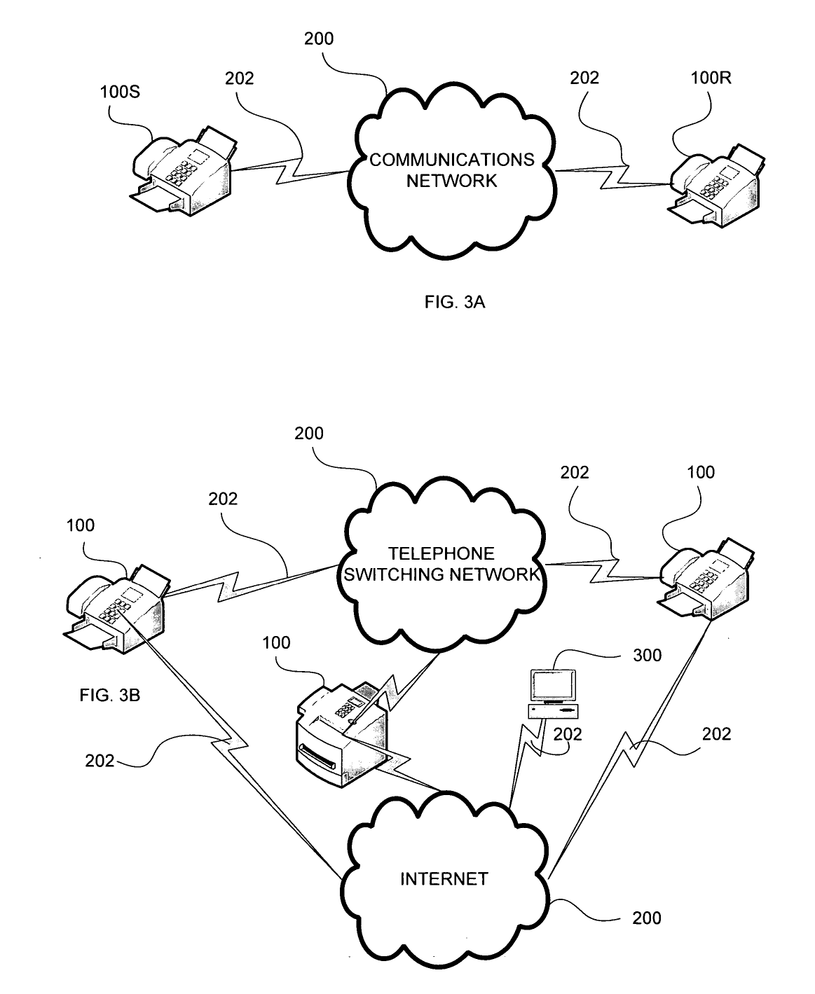

FIG. 3A provides an example of a communications link between a sending fax device 100S and a receiving fax device 100R. Sending fax device 100S connects via its network interface 134 (not shown in FIG. 3) to a network link 202. Network link 202 may be a phone line, a local area network, a dedicated fax line, an ISDN line, or some other communication medium that provides access to a communications network 200. Communications network 200 may be any of the number of different networks such as a cellular phone network, the Internet, a wide area network, a switched telephone network, or some other network. The receiving fax device lOOR may also be connected to a communications network 200 through its network interface 134 to a network link 202. Thus, when sending a fax communication to a receiving fax device 100R, the fax device 100S sends the fax communication data to the communications network 200, where it is ultimately received by the receiving fax device 100R via its network interface 134 and network link 202 (not shown in FIG. 3).

In the system described in FIG. 3A, the sending fax device 100S and receiving fax device 100R communicate through a single telecommunications network. In some embodiments, fax devices may be connected to multiple networks in order to communicate with various other types of devices. FIG. 3B provides an example of a multi-component/multi-network system. In that system, two communications networks 200A and 200B are provided. Communications network 200A is a telephone network over which fax devices 100 may communicate. Communications network 200B is a second network. Although in the example provided, communications network 200B is the Internet, one of skill in the art will appreciate that the second network may be some other communications network such as a cellular phone network. Fax devices 100 are connected to each of communications networks 200A and 200B. FIG. 3B also includes a computing device 300 connected to the communications network 200B. Computing device 300 may be a desktop computer, a laptop computer, a handheld computer or some other Internet-capable computing device. One of the fax devices 100 may be a multipurpose device which is configured to receive fax communications from the communications network 200A and forward them via e-mail to the computing device 300 where they can be retrieved by the recipient via e-mail.

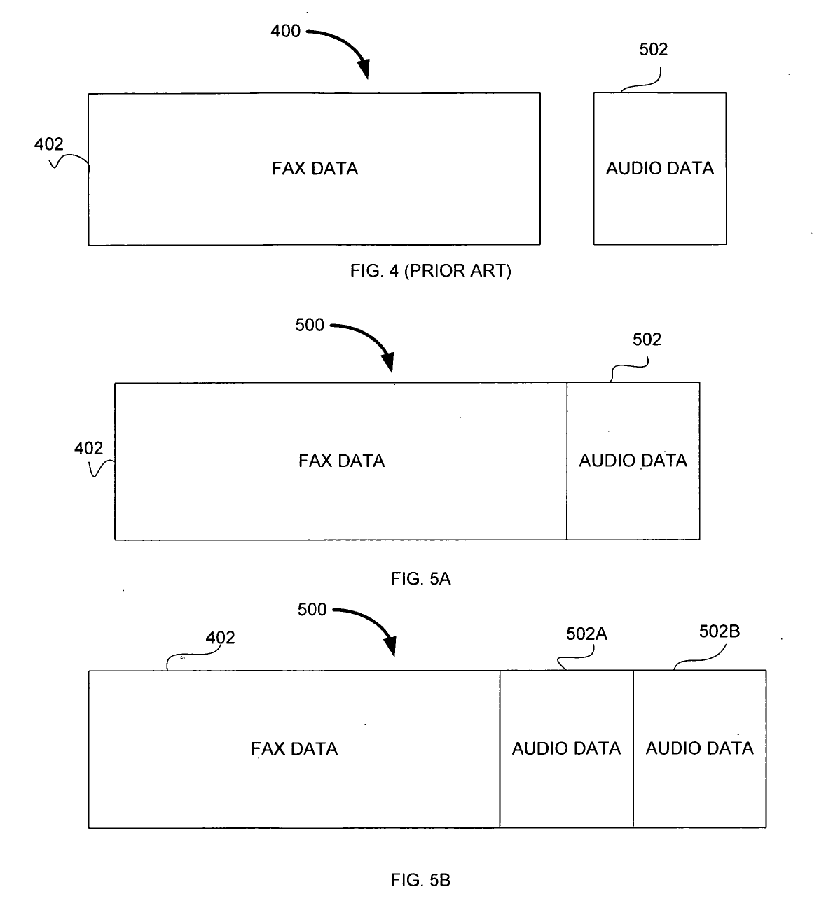

Current implementations fax communications do not allow for audio data to be integrated and stored with the fax communication in a single file or data structure. If a user wishes to send an explanatory message with a fax communication, they must send the audio data separately from the fax data as shown in FIG. 4. Because the audio data is separate from the fax data, the chances that the audio data does not reach the intended recipient are increased. Moreover, because the audio data is not specifically associated with the fax data, it may not be recognized as being relevant to the faxed document.

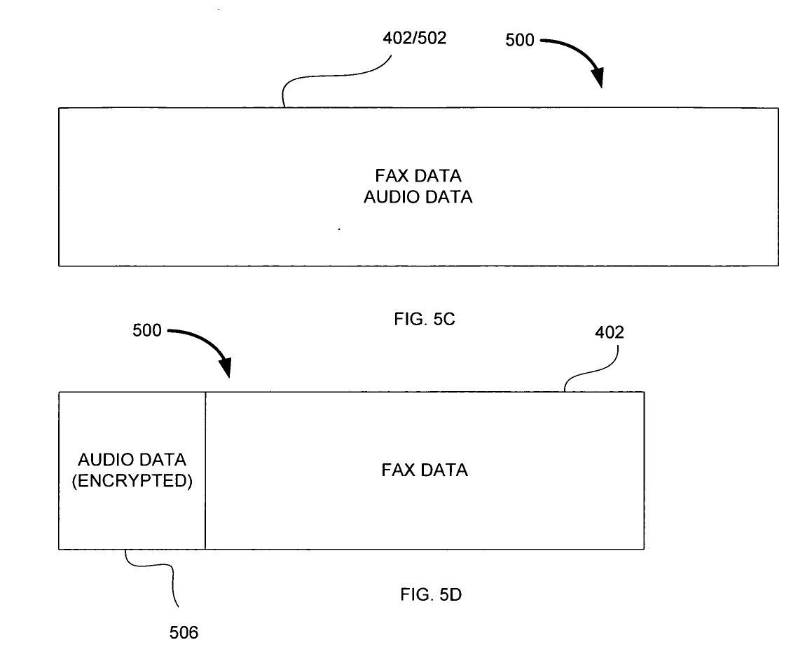

FIG. 5A provides an example of an integrated fax message 500 according to an embodiment of the invention which overcomes the limitations demonstrated by FIG. 4. Integrated fax message 500 includes the fax data 402, and also includes audio data 502. As shown in FIG. 5A, audio data 502 is appended to fax data 402 in the header or some other defined section of the fax data 402. Audio data 502 may be data created by the sound interface 138 based on audio input received through the handset 108. Audio data 502 may be in the form of an explanatory voice message input via the handset 108 providing information related to the contents of fax data 402.

When the audio data 502 comprises an explanatory voice message, the message may be stored in a memory 132 of the receiving fax device (such as fax device 100R from FIG. 3A) at least until the fax data 402 is printed. A user of receiving fax device 100R may listen to the explanatory voice message via the handset 108, and while listening to the voice message, the user may also instruct the receiving fax device 100R to print the received fax. If the fax message 400 is sent to a fax device 100 that permits fax forwarding (such as in the configuration shown in FIG. 3B), the recipient of the fax message 400 may instruct the fax device 100 to transmit the fax data 402 and the audio data 502 to a third fax device, or transmit it via e-mail to an e-mail account on the computing device 300.

Audio data 502 may also comprise a notification message providing a notification to the recipient that the fax has arrived at the fax machine. A receiving fax device such as 100R may receive a fax message that includes a notification message. Processor 130 will act on the audio data 502 depending on the form of notification supported by the receiving fax device 100R. In an embodiment, the receiving fax device 100R may be configured to provide notification to the recipient via a machine generated voice call. In this case, the processor 130 in conjunction with the network interface 134 will place a phone call to the recipient's telephone, and play the audio data using the sound interface 138 during the voice call notification.

In another embodiment notification to the recipient may be provided via an e-mail message or some other electronic delivery format. In this instance, processor 130 and sound interface 138 may be configured to append the notification message as an attachment to the e-mail message in a common audio format such as WAV, MP3, WMA, AVI, or some other digital audio file format so that the e-mail recipient may listen to the notification message on his computing device. In yet another embodiment, the receiving fax device 100R provides notification to the recipient via SMS or some other text-based messaging format. In this embodiment, the fax device 100 is configured to convert the notification voice message to text using voice recognition software 142 and to send the notification text message to the recipient, alerting the recipient to the presence of the fax. Alternatively, the receiving fax 100R may send an ordinary text message notifying the recipient of the presence of the fax, and store the notification message on the fax device 100 for playing on the handset 108 when the recipient retrieves the fax data at the receiving fax device.

Referring now to FIG. 5B, an alternative integrated fax message 500 allows for the inclusion of two sets of audio data. In an embodiment, the first set of audio data 502A may be an explanatory message, while the second set of audio data 502B may be a notification message. Alternatively, each set of audio data 502 may be an explanatory message or a notification message. This embodiment allows the sender to include a notification message for each recipient when the fax is sent to more than one recipient.

In the fax messages 500 shown in FIGS. 5A and 5B, audio data 502 is integrated with fax data 402 as a message header and sent as a single fax message 500. In another embodiment, audio data 502 may be imbedded into fax data 402, rather than appended to fax data 402 as a message header, as provided in FIG. 5C.

In yet another embodiment, the sender may wish that only the intended recipient have access to the explanatory information included in an explanatory message. By way of example and not of limitation, assume fax message 500 includes non-confidential information. The sender of this fax data wishes to include comments and opinions regarding the non-confidential information, but does not want anyone other than the intended recipient to have access to his comments. FIG. 5D illustrates fax message 500, which includes fax data 402 and encrypted audio data 506. In creating a fax message 500 which includes encrypted audio data 506, the sender may create the fax message in the same manner as described above in connection with FIG. 5A. However, upon using the handset 108 to record the explanatory message, the sender provides an indication to the sending fax device 100S instructing the encryption module 144 to intercept the data after it has been processed by the sound interface 138, and to encrypt the audio data. When the fax message 500 is received at fax device 100R, the intended recipient then decrypts the encrypted audio portion of the fax message and listens to the confidential explanatory comments.

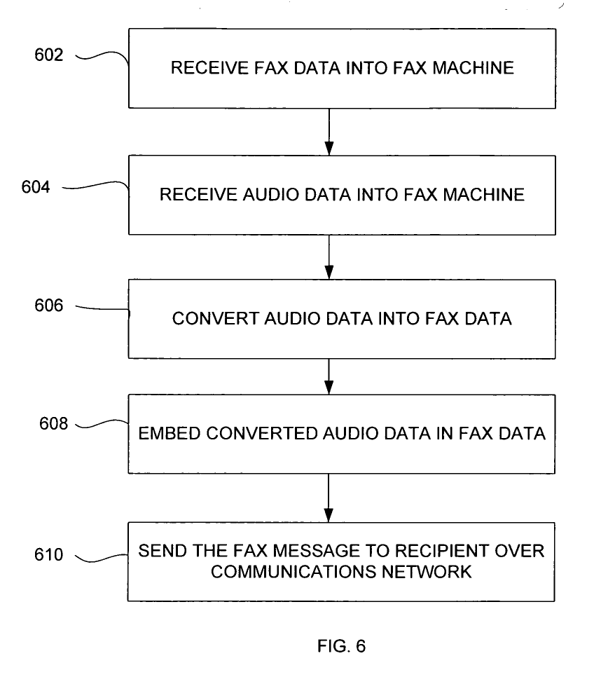

Referring now to FIG. 6, a flow chart illustrating a method of managing an integrated fax and audio message such as the fax message 500 in the fax device 100 is provided in accordance with an aspect of the invention. According to the method provided, at block 602, the fax device 100 receives fax data 402. Fax data 402 may be received into the memory 132 by way of a sensor 136, which scans documents as they are fed into the fax device 100 from the document feeder 102. At block 604, the fax device 100 receives audio data 502. Audio data 502 may be input into the fax device 100 via handset 108, or some other audio input device such as a microphone or a Bluetooth-capable device. In one embodiment, a user may pick up the handset 108 and speaking an explanatory voice message into the hand set for processing by the fax device processor 130 and sound interface 138 into digital audio data. Next, at block 606, fax device 100 converts the digital audio data into a format that may be included with the fax data 402 in a structure such as those as provided in FIGS. 5A through 5D. Proceeding to block 608, the system then embeds the converted audio data in the fax data. As discussed above, this conversion may be achieved by embedding the audio data in the fax data, or by appending the audio data in a header of the fax data, or possibly by some other embedding technique. Then, at block 610, the fax device 100 sends the integrated fax message 500 to the communications network 200 via the network interface 134 and network link 202.

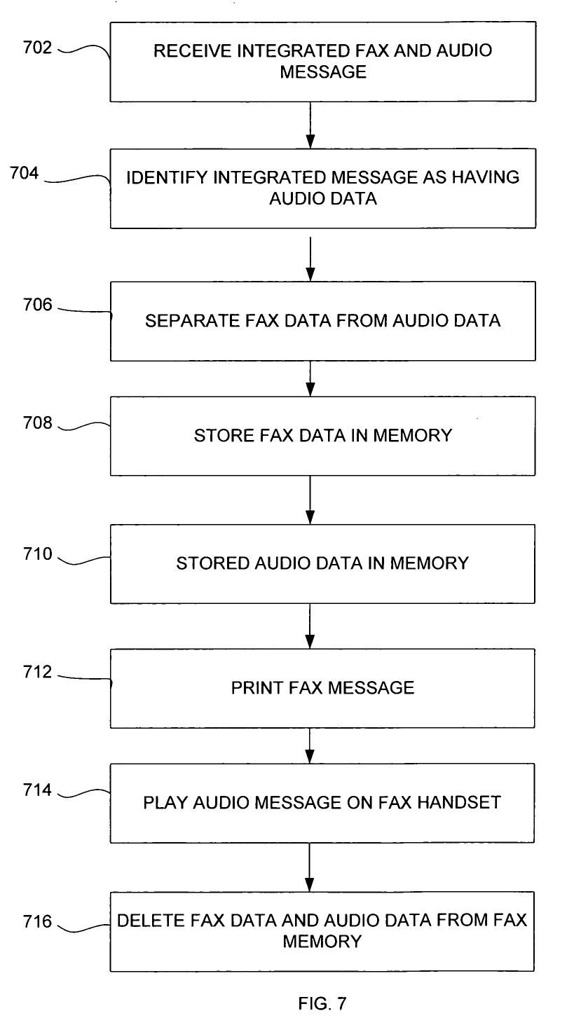

In another embodiment, the fax machine 100 receives fax message 500 and handles it according to the method shown in FIG. 7. At block 702, the fax message 500 is received from the communications network 200 and the network link 202 by the fax device 100. Next at block 704, the fax device 100 identifies the fax message 500 as including audio data 502. The audio data 502 may include an explanatory message or a notification message or both. This identification may be provided by identifying software stored in the memory 132 working in conjunction with the processor 130, or by some other means. Next at block 706, the fax data 402 is separated from the audio data 502. Like the identification process above, the separation of fax data from audio data may be achieved via software embedded in the processor 130, or software stored in the memory 132. Upon separating the fax data 402 from audio data 502, at block 708 the fax data 402 is stored in the memory 132 of the fax device 100. Next, at block 710, the separated audio data 502 is also stored in the memory 132. Typically audio data 502 will be stored in a format that is separate from fax data 402 such as a digital audio format such as MP3, WAV, WMA, AVI, or some other format.

Proceeding to block 712, the fax device 100 prints the fax data 402. Next, at block 714, the user may lift the handset 108, and in response, the fax device 100 plays audio data 502 to the handset by converting digital audio data to audible sound using the sound interface 138. Once fax data 402 has printed and audio data 502 has been played or listened to, the fax device 100 can be configured to delete both the fax data and audio data from the fax memory 132. Alternatively, if there is sufficient storage, the fax message 500 may be stored in the memory 132 to be accessed at a later time.

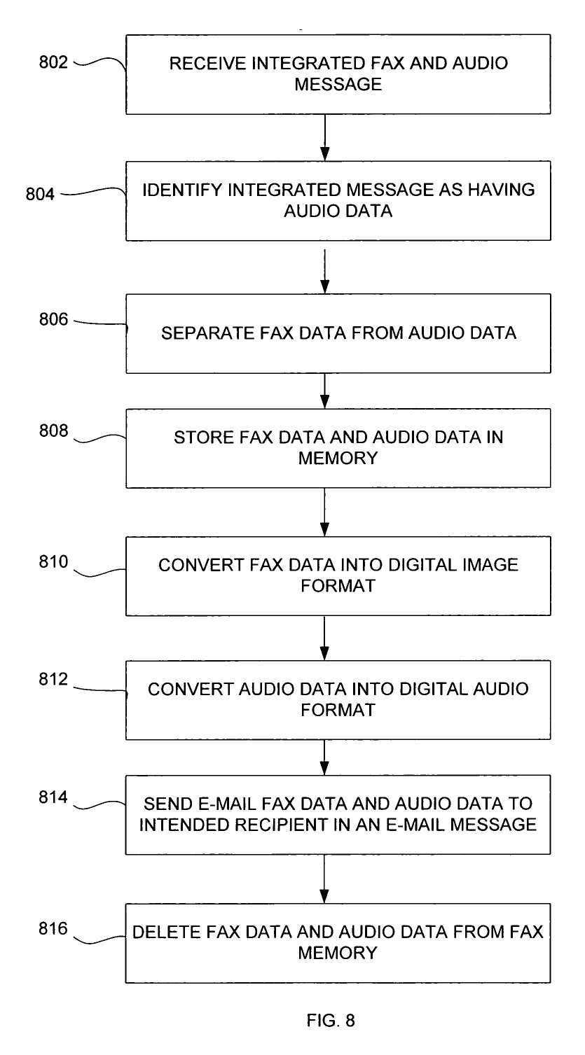

In yet another embodiment, a fax device 100 may be configured to handle an integrated fax message by converting the fax message into a format that may be sent electronically via e-mail or some other electronic communication means. With reference to FIG. 8, at block 802, fax message 500 is received into the fax device 100 from the communications network 200 and the network link 202. Next at block 804, the fax device 100 identifies the fax message 500 as including audio data 502. Next at block 806, fax data 402 and audio data 502 are separated. Upon separating the fax data 402 from audio data 502, the system moves to block 808, where separated fax data 402 and audio data 502 are stored in the memory 132. Next, at block 810, fax data 402 is converted into a digital image format such as TIF, JPEG, PDF, GIF, or some other format. At block 812, the audio data 502 is converted into a digital audio format such as MP3, WAV, WMA, AVI, or some other format. At block 814, the converted audio data and fax data are attached to an e-mail message and e-mailed to the intended recipient. Lastly, at block 816, the fax message is removed from the memory 132 of the fax device 100.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A fax message comprising:
fax data; and
voice data.

2. The fax message of claim 1, wherein the voice data comprises a digitally encoded voice message.

3. The fax message of claim 2, wherein the digitally encoded voice message is embedded into the fax data.

4. The fax message of claim 3, wherein the voice data includes an explanatory message.

5. The fax message of claim 4, wherein the voice data further comprises a second digitally encoded voice message.

6. The fax message of claim 5, wherein the second digitally encoded voice message comprises a notification message.

7. A fax device comprising:
a transceiver configured to receive a fax message intended for a recipient, the fax message comprising voice data and fax data;
a data storage device configured to store the received fax message;
a processor configured separate the voice data from the fax data and further configured to convert the voice data into audible sound waves in response to an input command; and
a sound interface configured to receive and to play the converted voice data.

8. The fax device of claim 7, further comprising a display interface configured to provide an indication that the fax message includes voice data.

9. The fax device of claim 7, wherein the sound interface plays the voice data on a handset console.

10. The fax device of claim 9, wherein the voice data comprises a digitally encoded voice message.

11. The fax device of claim 10, wherein the digitally encoded voice message comprises an explanatory message.

12. The fax device of claim 11, wherein the processor is further configured to print the fax data after converting the explanatory message to audible sound.

13. The fax device of claim 12, wherein the voice data further comprises a second digitally encoded voice message.

14. The fax device of claim 13, wherein the second message is a notification message.

15. The fax device of claim 14, wherein the processor is further configured to send the notification message to the intended recipient in response to receiving the fax message.

16. The fax device of claim 15, wherein the processor is further configured to forward the notification message, the explanatory message and the fax data to the intended recipient in an e-mail message.

17. The fax device of claim 16, wherein the notification message, the explanatory message and the fax data, are forwarded as attachments to an e-mail message.

18. A fax device comprising:
a fax data input interface configured to receive fax data;
a voice data input interface configured to receive voice data, the voice data being related to the fax data;
a storage device configured to store the received fax data and the received voice data;
a processor configured to associate the stored fax data with the stored voice data; and
a transceiver configured to send the associated fax data and voice data as a fax message to a communications network.

19. The fax device of claim 18, wherein the voice data comprises an explanatory message.

20. The fax device of claim 18, wherein the voice data comprises a notification message.

21. The fax device of claim 18, wherein the voice data input interface is a handset console of the fax device.

22. The fax device of claim 21, further comprising a user interface, the user interface being configured to prompt a user to enter an explanatory message or a notification message via the handset console of the fax device, concurrent with fax data being input into the fax device.

23. The fax device of claim 18, wherein the voice data input interface comprises a Bluetooth interface configured to receive voice data from a Bluetooth capable device.

24. A method of managing an integrated fax and audio message in a fax machine comprising receiving an integrated fax and audio message, the message having an intended recipient, and the message further including fax data and audio data.

25. The method of claim 24, further comprising:
identifying the integrated fax and audio message as having audio data; and
separating the fax data from the audio data.

26. The method of claim 25, further comprising:
storing the separated fax data and audio data in a data storage device of the fax machine.

27. The method of claim 26, further comprising:
receiving input to print the received fax message; and
playing the received audio message.

28. The method of claim 27, wherein playing the received audio message comprises playing the message on a handset of the fax machine.

29. The method of claim 28, further comprising:
receiving a command to delete the fax message from the fax machine; and
in response to the command, deleting the stored fax data from the memory and the audio data from the memory.

30. The method of claim 26, further comprising:
converting the received integrated fax and audio message into an e-mail message; and
sending the e-mail message to the intended recipient.

31. The method of claim 30, wherein converting the received integrated fax and audio message comprises:
converting the fax data to a digital image format; and
converting the audio data to a digital audio format.

32. The method of claim 29, wherein the audio data is an explanatory message.

33. The method of claim 26, further comprising:
forwarding the audio message to the intended recipient to notify the intended recipient of the presence of the received fax message.

34. A method of sending a fax message from a fax device to an intended recipient comprising:
associating audio data with fax data to create a fax message; and
sending the fax message to the recipient over a communications network.

35. The method of claim 34, further comprising:
receiving the audio data and the fax data into the fax device.

36. The method of claim 34, wherein associating the audio data with the fax data comprises:
converting the audio data into fax data; and
embedding the converted audio data in the received fax data.

37. A fax device comprising:
means for receiving fax data;
means for receiving voice data, the voice data being related to the fax data;
means for storing the received fax data and the received voice data;
means for associating the stored fax data with the stored voice data; and
means for sending the associated fax data and voice data as a fax message to a communications network.

38. A fax device comprising:
means for receiving from a communications network a fax message intended for a recipient, the fax message comprising voice data and fax data;
means for storing the received fax message;
means for separating the voice data from the fax data and for converting the voice data into audible sound in response to an input command; and
means for receiving and playing the converted voice data.
